(19) United States
(12) Patent Application Publication
(10) Pub. No.: US 2025/0083115 A1
(43) Pub. Date: Mar. 13, 2025

(54) SILICONE MONOMER SYNTHESIS DEVICE WITH BUILT-IN SEPARATION ASSEMBLY

(71) Applicant: Qingdao University of Science & Technology, Qingdao City (CN)

(72) Inventors: Guanghui CHEN, Qingdao City (CN); Pan ZHANG, Qingdao City (CN); Junling FAN, Qingdao City (CN); Fei GAO, Qingdao City (CN); Weiwen WANG, Qingdao City (CN)

(21) Appl. No.: 18/531,049

(22) Filed: Dec. 6, 2023

(30) Foreign Application Priority Data
Sep. 11, 2023 (CN) 2023111671812

(51) Int. Cl. B01J 8/18

(52) U.S. Cl. CPC B01J 8/1863; B01J 8/1827; B01J 8/1836; B01J 8/1872; B01J 2208/00123; B01J 2208/00132; B01J 2208/00938; B01J 2208/00991

(57) ABSTRACT

A silicone monomer synthesis device with a built-in separation assembly is disclosed, and includes a device main body, a separation assembly, a return assembly, and a gas outlet pipe. The device main body is internally provided with the separation assembly, particles separated by the separation assembly can return to a reaction zone main cylinder through the return assembly, and a purified gas is discharged from a reactor cylinder through the gas outlet pipe.

### TECHNICAL FIELD

The present disclosure relates to the technical field of multi-phase flow reaction, and in particular to a silicone monomer synthesis device with a built-in separation assembly.

### BACKGROUND

Silicone material is widely used in aerospace, electronic appliances, automobiles, medical and health fields due to its numerous excellent characteristics of high and low temperature resistance, electrical insulation, oxidation stability, weather resistance, flame retardancy, corrosion resistance and physiological inertia. The synthesis of silicone monomer is the basis of materials and industry in silicone, which is usually synthesized by a Rochow direct method. Methyl silicone monomer, which accounts for more than 80% of silicone monomer, is mainly synthesized by directly catalyzing silicon powder particles and methyl chloride gas in a fluidized bed reactor by Cu-based catalysts and additives such as zinc and tin. The methyl chloride is used as a fluidizing medium and reactant at the same time, and unreacted methyl chloride, gaseous methyl chlorosilane and by-products entraining catalysts and fine silicon particles are discharged from the reactor.

The selectivity of a target product (Dimethyldichlorosilance, M2), i.e., a proportion of M2 to all products, and a conversion rate of methyl chloride (1 minus the quotient of the methyl chloride flow at the reactor outlet divided by the methyl chloride flow at the reactor inlet) are the main indicators to measure the performance of the monomer fluidized bed reactor. To improve the conversion rate of methyl chloride, the method of increasing the gas velocity of methyl chloride at the reactor inlet is usually adopted in industry, which leads to more and larger silicon particles and catalysts being entrained out of the reactor by gas.

At present, most fluidized bed reactors are externally provided with one-stage or multi-stage cyclone separators to collect the discharged silicon particles and catalysts and to transport the collected silicon particles and catalysts back to the reactor in batch discontinuously or continuously. A synthesis system composed of a reactor and a cyclone separator is disclosed in Chinese patent application publication NO. CN101139353A and U.S. Pat. No. 4,281,149. Coarse particles separated by the separator are directly returned to the reactor, and fine particles obtained after multi-stage separation need to be post-treated and then recycled to the reactor or discharged from the process. Such a way not only leads to serious wear of fluidized bed reactor and subsequent equipment, high material consumption, unstable catalyst amount in the reactor, large operating parameter fluctuation and unstable product quality, but also causes the problem of equipment blockage caused by high-boiling substances generated by a side reaction among the silicon particles, the catalysts and unreacted methyl chloride gas due to improper heat preservation measures.

A silicone fluidized bed reactor with a built-in cyclone separator is disclosed in Chinese patent NO. CN203598804U and Chinese patent application publication NO. CN102078784A. The cyclone separator is installed in the fluidized bed reactor, which is beneficial to prolonging the residence time of fine silicon particles and catalysts in the reactor without additional heat preservation measures. Moreover, great fluctuation of operating parameters such as temperature in the reaction bed can be avoided. However, the built-in cyclone separator leads to large structural size of equipment. For example, the cyclone separator provided according to Chinese patent NO. CN203598804U is installed in an enlarged section of the reactor, the diameter of the enlarged section is up to 2.5 times the diameter of a reaction section, and the height of the enlarged section is up to 6.25 times the diameter of the reaction section. The diameter of the reaction section of the silicone synthesis fluidized bed reactor in industrial production can reach 3 m and more. Therefore, the diameter of the enlarged section of the synthesis device may reach 6-7 m, and the height of the enlarged section may reach 18 m and higher, leading to the great increase of equipment, infrastructure and operation costs, and difficult equipment manufacturing and transportation.

### SUMMARY

An objective of the present disclosure is to provide a silicone monomer synthesis device with a built-in separation assembly, so as to solve the problems in the prior at. The output of silicon particles and catalyst particles at an outlet is greatly reduced, the problems of serious wear of subsequent equipment, large operating parameter fluctuation and unstable product quality, as well as the problems of the generation of high-boiling substances and equipment blockage are both avoided.

To achieve the objective above, the present disclosure provides the following solutions: a silicone monomer synthesis device with a built-in separation assembly includes:
a device main body including a heat exchange assembly, a cylindrical reaction zone main cylinder, an inverted conical cylinder, and a gas inlet distributor, where the cylindrical reaction zone main cylinder, the inverted conical cylinder and the gas inlet distributor are sequentially connected from top to bottom; the heat exchange assembly is installed inside the cylindrical reaction zone main cylinder, and a gas-solid two-phase flow composed of silicon particles and gas substances in the cylindrical reaction zone main cylinder exchanges heat with the heat exchange assembly;
a separation assembly including a riser, a closed head, and an elbow pipe, where the closed head is arranged at a top of the cylindrical reaction zone main cylinder, an inlet communicating with the riser is provided on the closed head, the elbow pipe is connected to an outlet of the riser, and the elbow pipe is arranged in a tangential direction of the riser;
a return assembly arranged between a circumferential wall located at a bottom of the closed head in the cylindrical reaction zone main cylinder and an inner wall of the cylindrical reaction zone main cylinder, where a return pipe of the return assembly communicates with a middle lower part of the cylindrical reaction zone main cylinder; and
a gas outlet pipe, arranged at the top of the cylindrical reaction zone main cylinder and located at a middle upper part of the separation assembly, where an outlet of the elbow pipe communicates with the gas outlet pipe, and an annular gap is reserved between the riser and an inner wall of the gas outlet pipe.

Preferably, the gas inlet distributor is a flat distributor or a conical distributor, and is of a plate type structure or a nozzle type structure.

Preferably, a heat exchange tube of the heat exchange assembly is in the form of a finger tube or a U-shaped tube.

Further, the finger heat exchange tube of the heat exchange assembly is a single-pass tube.

Further, the U-shaped tube of the heat exchange assembly includes 1-5 sets of U-shaped heat exchange tubes connected in series.

Preferably, a center of the riser coincides with that the cylindrical reaction zone main cylinder, a diameter of the riser is ⅕-⅛ times a diameter of the cylindrical reaction zone main cylinder, and a height of the riser is 1-3 times the diameter of the riser itself.

Preferably, a cross section of the closed head is in the shape of a right frustum of cone, and a deviation distance between a center of the cone of the closed head and a center of the riser is 0.3-0.45 times the diameter of the cylindrical reaction zone main cylinder. The return pipe of the return assembly is a cylindrical pipeline.

Preferably, the cross section of the closed head is in the shape of an inverted frustum of cone, and the center of cone of the closed head coincides with the center of the riser. The return assembly is an annular space between the cylindrical reaction zone main cylinder and an inner cylinder located at the bottom of the closed head.

Preferably, the diameter of the gas outlet pipe is 1.8-2.4 times the diameter of the riser.

Preferably, an outer wall surface of the elbow pipe is tangent to the riser, an upper wall surface of the elbow pipe is aligned with a top end of the riser, the number of the elbow pipes is 3-6, and each elbow pipe is symmetrically distributed with respect to a central axis of the riser.

Preferably, a central axis of the elbow pipe is a curve of second order, and is horizontally arranged. The cross section of the elbow pipe is in a rectangular, circular, or elliptic shape.

Further, the area of a rectangular cross section of the elbow pipe is 20-40% of the area of the cross section of the riser, or a diameter of the circular section of the elbow pipe is 20-40% of the diameter of the riser, or a major axis and a minor axis of an elliptic section of the elbow pipe are 20-40% and 10-20% of the diameter of the riser, respectively.

Compared with the prior art, the present disclosure obtains the following beneficial technical effects:

A silicone monomer synthesis device with a built-in separation assembly provided by the present disclosure includes a device main body, a separation assembly, a return assembly, and a gas outlet pipe. The device main body is internally provided with the separation assembly, particles separated by the separation assembly can return to a reaction zone main cylinder through the return assembly, and a purified gas is discharged from a reactor cylinder through the gas outlet pipe. The monomer synthesis device provided by the present disclosure greatly reduces the output of silicon particles and catalyst particles at an outlet thereof, thus avoiding the problems of serious wear of subsequent equipment, the large fluctuation of operating parameters and unstable product quality, as well as the problems of the blockage of equipment caused by the generation of high-boiling substances. Meanwhile, the diameter of the riser of the separation assembly is only ⅕-⅛ times the diameter of the reaction zone main cylinder, there is no need of an enlarged section, and the height of the separation assembly is only ⅕-⅗ times the diameter of the reaction zone main cylinder. The space scale of the device is greatly reduced, and equipment, infrastructure and operation costs are also greatly reduced, thus avoiding the problem of difficult equipment manufacturing and transportation caused by large space scale of equipment.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a silicone monomer synthesis device with a built-in separation assembly according to Embodiment I;

FIG. 2 is a structural schematic diagram of a silicone monomer synthesis device with a built-in separation assembly according to Embodiment II;

FIG. 3 is a sectional diagram in A-A direction in FIG. 1 and FIG. 2.

In the drawings: 1—riser; 2—closed head; 3—cylindrical reaction zone main cylinder; 4—heat exchange assembly; 5—inverted conical cylinder; 6—gas inlet distributor; 7—return port; 8—return assembly; 81—inner cylinder; 82—cylindrical pipeline; 9—elbow pipe; 10—gas outlet pipe; 11—inlet; 12—outlet; 13—separation space; 14—annular gap; 15—outlet of gas outlet pipe.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An existing synthesis system with an internal cyclone separator has the problems of large space occupied by separation assembly, high equipment, infrastructure and operation costs, and difficult equipment manufacturing and transportation. However, a synthesis system with an external cyclone separator has the problems of serious wear of subsequent equipment, high material consumption, unstable amount of catalyst in the reactor, large operation parameter fluctuation, and unstable product quality. To solve the problem above, a silicone monomer synthesis device with a built-in separation assembly is provided.

In order to make the objectives, technical solutions and advantages of the present disclosure more clearly, the present disclosure is further described in detail below with reference to the embodiments.

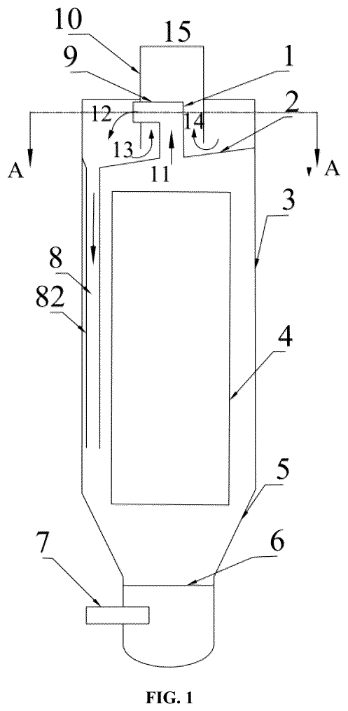

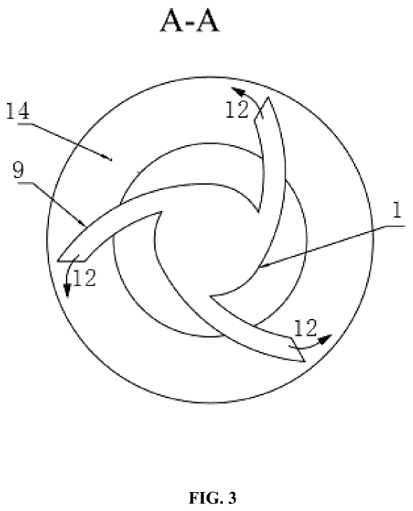

As shown in FIGS. 1 to 3, a silicone monomer synthesis device with a built-in separation assembly mainly includes:
at least one heat exchange assembly 4;
at least one cylindrical reaction zone main cylinder 3;
at least one riser 1;
at least one elbow pipe 9;
at least one return assembly 8;
at least one inverted conical cylinder 5;
at least one gas inlet distributor 6;
at least one gas outlet pipe 10; and
at least one closed head 2.

A device main body of the silicone monomer synthesis device is composed of the heat exchange assembly 4, the cylindrical reaction zone main cylinder 3, the inverted conical cylinder 5, and the gas inlet distributor 6. The cylindrical reaction zone main cylinder 3, the inverted conical cylinder 5 and the gas inlet distributor 6 are connected in sequence. The heat exchange assembly 4 is installed inside the cylindrical reaction zone main cylinder 3, and the riser 1, the closed head 2, the elbow pipe 9 and the return assembly 8 form a separation assembly.

Silicon particles react with a methyl chloride gas in the cylindrical reaction zone main cylinder under the catalysis of catalysts and additives, and a gas-solid two-phase flow composed of the silicon particles and gas substance exchange heat with the heat exchange assembly 4, and a temperature of the gas-solid two-phase flow in the cylindrical reaction zone main cylinder 3 remains unchanged. A gaseous product, unreacted methyl chloride and entrained silicon particles and catalyst particles in the cylindrical reaction zone main cylinder 3 enter a separation assembly from an inlet 11 of the riser 1, and then enter a separation space 13 from an outlet 12 of the elbow pipe 9. Under the action of a centrifugal force, the silicon particles are separated from gaseous substances, and return to a middle lower part of the cylindrical reaction zone main cylinder 3 after entering the feed system 8. The purified gas enters an annular gap 14 between the riser 1 and the gas outlet pipe 10, and then is discharged from an outlet 15 of the gas outlet pipe.

One side of the gas inlet distributor 6 is also provided with a return port 7. When the whole silicone monomer synthesis device with the built-in separation assembly is free of reaction, the materials can be recycled or returned through the return port 7.

When the closed head 2 is in the shape of an inverted cone and a center of the inverted cone coincides with a center of the riser 1, the return assembly 8 is an annular space between the cylindrical reaction zone main cylinder 3 and the inner cylinder 81. When the closed head 2 is in the shape of a regular cone, the center of the regular cone deviates from the center of the riser 1 by 0.3-0.45 times the diameter of the cylindrical reaction zone main cylinder 3, and the return assembly 8 is a cylindrical pipeline 82.

### Embodiment I

As shown in FIG. 1, silicon particles and catalyst particles are in a cylindrical reaction zone main cylinder 3, a methyl chloride gas enters the cylindrical reaction zone main cylinder 3 from a nozzle on a conical gas inlet distributor 6, the silicone particles react with the methyl chloride gas under the catalysis of the catalysts and additives, so as to generate methyl chlorosilane. A gas-solid two-phase flow exchanges heat with the heat exchange system 4 composed of three sets of serially connected U-shaped tubes, and a temperature of the gas-solid two-phase flow in the cylindrical reaction zone main cylinder 3 is kept at 290° C.

A gaseous product and unreacted gaseous methyl chloride in the cylindrical reaction zone main cylinder 3 entrain silicon particles and catalyst particles into a separation device from an inlet 11 of a riser 1, and then enter a separation space 13 from an outlet 12 of the elbow pipe 9 with a rectangular cross section. Under the action of a centrifugal force, the silicon particles are separated from the gaseous substance. The head seal 2 is in the shape of a regular cone, the center of the regular cone deviates from the center of the riser 1 by 0.45 times the diameter of the cylindrical reaction zone main cylinder 3, and the silicon particles return to a middle lower part of the cylindrical reaction zone main cylinder 3 from a cylindrical pipeline 82 of the return assembly 8. The purified gas enters an annular gap 4 between the riser 1 and the gas outlet pipe 10, and then is discharged from an outlet 15 of the gas outlet pipe.

This embodiment is actual engineering application, a diameter of the cylindrical reaction zone main cylinder 3 is 3.8 m, a diameter of the riser 1 is 0.74 m, and a height of the riser 1 is 1.5 m. The number of the elbow pipes 9 is three, a cross section of the elbow pipe 9 is rectangular (0.15 m×0.30 m), and a diameter of a pipe of the return assembly 8 is 50 mm. A particle size of the silicon particle ranges from 5 μm to 140 μm, a median particle size is 80 μm, and an apparent gas velocity of the methyl chloride gas is 0.2 m/s. The industrial data show that the entrainment of solid particles at an outlet of the silicone monomer synthesis device is 0.54 kg/h (compared with 10-40 kg/h in the prior art), the pressure and temperature of the synthesis device are stable, the average selectivity of M2 reaches 89.8%, and the yield of chlorosilane is 140.6 g/(cm³·s), so the performance of methyl silicone monomer synthesis device has a high level.

### Embodiment II

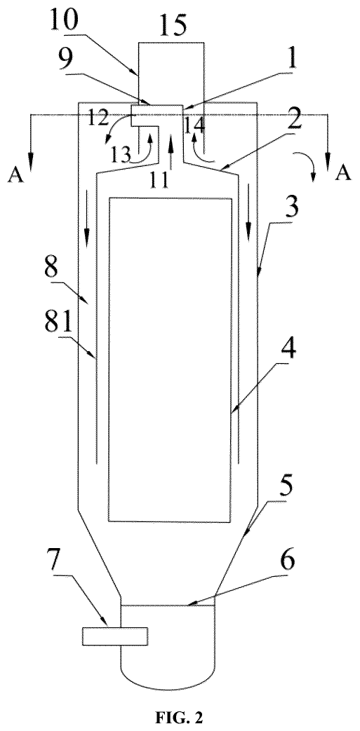

As shown in FIG. 2, the implementation process in Embodiment II is similar to that in Embodiment I. Embodiment II mainly differs from Embodiment I in that the closed head 2 in Embodiment II is in the shape of an inverted cone, which replaces the closed head in the shape of regular cone in Embodiment I.

The above process is numerically calculated and analyzed, the diameter of the cylindrical reaction zone main cylinder 3 is 0.6 m, the diameter of the riser 1 is 0.12 m, and the height of the riser 1 is 0.25 m. The number of the elbow pipes 9 is three, the cross section of the elbow pipe 9 is rectangular (12 mm×24 mm), and the diameter of the pipe of the return assembly 8 is 10 mm. The particle size of the silicon particle ranges from 5 μm to 140 μm, the median particle size is 80 μm, and the apparent gas velocity of the methyl chloride gas is 0.2 m/s. The data show that the separation efficiency of the solid particles at the outlet of the silicone monomer synthesis device is 95.2%, the entrainment of the solid particles is 135 mg/h, the pressure and temperature of the synthesis device are stable, the average selectivity of M2 reaches 87.6%, and the yield of chlorosilane is 162.6 g/(cm³·s), so the performance of methyl silicone monomer synthesis device has a high level.

The silicone monomer synthesis device with a separation assembly provided by the present disclosure has the following features:

(1) An existing silicone monomer synthesis device with an external separation assembly has large output of silicon particles and catalyst particles at an outlet, which not only leads to serious wear of fluidized bed reactor and subsequent equipment, high material consumption, unstable catalyst amount in the reactor, the large fluctuation of operating parameters and unstable product quality, but also causes the problem of the blockage of equipment caused by high-boiling substances generated by a side reaction among the silicon particles, the catalysts and unreacted methyl chloride gas due to improper heat preservation measures. The monomer synthesis device provided by the present disclosure greatly reduces the output of silicon particles and catalyst particles at an outlet, and solves the problems of serious wear of subsequent equipment, the large fluctuation of operating parameters and unstable product quality, as well as the problems of the blockage of equipment caused by the generation of high-boiling substances.

(2) An existing silicone monomer synthesis device with an internal cyclone separator is large in structural size, leading to the great increase of equipment, infrastructure and operation costs, and the difficult equipment manufacturing and transportation. The diameter of the riser 1 in the monomer synthesis device provided by the present disclosure is only ⅕-⅛ times the diameter of the cylindrical reaction zone main cylinder 3, there is no need of an enlarged section, and the height of the separation assembly is only ⅕-⅗ times the diameter of the reaction zone main cylinder. The space scale of the device is greatly reduced, and the equipment, infrastructure and operation costs are also greatly reduced, thus avoiding the problem of difficult equipment manufacturing and transportation caused by large space scale of equipment.

It should be noted that it is apparent to those skilled in the art that the present disclosure is not limited to the details of the above exemplary embodiments, and can be realized in other specific forms without departing from the spirit or basic characteristics of the present disclosure. Therefore, the embodiments should be considered as exemplary and non-limiting in all aspects, and the scope of the present disclosure is defined by the appended claims rather than the above description, so it is intended to embrace all changes that fall within the meaning and range of equivalents of the claims, and any reference signs in the claims should not be regarded as limiting the claims involved. Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A silicone monomer synthesis device with a built-in separation assembly, comprising:
a device main body comprising a heat exchange assembly, a cylindrical reaction zone main cylinder, an inverted conical cylinder, and a gas inlet distributor, wherein the cylindrical reaction zone main cylinder, the inverted conical cylinder and the gas inlet distributor are sequentially connected to one another from top to bottom; the heat exchange assembly is installed inside the cylindrical reaction zone main cylinder, and a gas-solid two-phase flow composed of silicon particles and gas substances in the cylindrical reaction zone main cylinder exchanges heat with the heat exchange assembly;
a separation assembly comprising a riser, a closed head, and an elbow pipe, wherein the closed head is arranged at a top of the cylindrical reaction zone main cylinder, an inlet communicating with the riser is provided on the closed head, the elbow pipe is connected to an outlet of the riser, and the elbow pipe is arranged in a tangential direction of the riser;
a return assembly arranged between a circumferential wall located at a bottom of the closed head in the cylindrical reaction zone main cylinder and an inner wall of the cylindrical reaction zone main cylinder, wherein a return pipe of the return assembly communicates with a middle lower part of the cylindrical reaction zone main cylinder; and
a gas outlet pipe arranged at the top of the cylindrical reaction zone main cylinder and located at a middle upper part of the separation assembly, wherein an outlet of the elbow pipe communicates with the gas outlet pipe, and an annular gap is reserved between the riser and an inner wall of the gas outlet pipe.

2. The silicone monomer synthesis device with a built-in separation assembly according to claim 1, wherein the gas inlet distributor is a flat distributor or a conical distributor.

3. The silicone monomer synthesis device with a built-in separation assembly according to claim 1, wherein a heat exchange tube of the heat exchange assembly is in the form of a finger tube or a U-shaped tube.

4. The silicone monomer synthesis device with a built-in separation assembly according to claim 1, wherein a center of the riser coincides with that of the cylindrical reaction zone main cylinder, a diameter of the riser is ⅕-⅛ times a diameter of the cylindrical reaction zone main cylinder, and a height of the riser is 1-3 times the diameter thereof.

5. The silicone monomer synthesis device with a built-in separation assembly according to claim 1, wherein a cross section of the closed head is in a shape of a right frustum of cone, and a deviation distance between a center of the cone of the closed head and a center of the riser is 0.3-0.45 times the diameter of the cylindrical reaction zone main cylinder; and the return pipe of the return assembly is a cylindrical pipeline.

6. The silicone monomer synthesis device with a built-in separation assembly according to claim 1, wherein a cross section of the closed head is in a shape of an inverted frustum of cone, and a center of the cone of the closed head coincides with a center of the riser; and the return assembly is an annular space between the cylindrical reaction zone main cylinder and an inner cylinder located at the bottom of the closed head.

7. The silicone monomer synthesis device with a built-in separation assembly according to claim 1, wherein a diameter of the gas outlet pipe is 1.8-2.4 times a diameter of the riser.

8. The silicone monomer synthesis device with a built-in separation assembly according to claim 1, wherein an outer wall surface of the elbow pipe is tangent to the riser, an upper wall surface of the elbow pipe is aligned with a top end of the riser, a number of the elbow pipe is three to six, and each elbow pipe is symmetrically distributed with respect to a central axis of the riser.

9. The silicone monomer synthesis device with a built-in separation assembly according to claim 1, wherein a central axis of the elbow pipe is a curve of second order, and is horizontally arranged; and a cross section of the elbow pipe is in a rectangular, circular, or elliptic shape.
